(19) United States
(12) Patent Application Publication
(10) Pub. No.: US 2017/0341252 A1
(43) Pub. Date: Nov. 30, 2017

(54) LATCHING TOOL SHEATH

(71) Applicant: Hogue Tool & Machine, Inc., Paso Robles, CA (US)

(72) Inventor: Patrick Leonard Hogue, Paso Robles, CA (US)

(73) Assignee: Hogue Tool & Machine, Inc., Paso Robles, CA (US)

(21) Appl. No.: 15/596,005

(22) Filed: May 16, 2017

Related U.S. Application Data
(60) Provisional application No. 62/341,186, filed on May 25, 2016.

(51) Int. Cl. B26B 29/02; B26B 3/06; A45F 5/02

(52) U.S. Cl. CPC B26B 29/025; A45F 5/02; B26B 3/06

(57) ABSTRACT

Latching tool sheaths have a body defining an elongated sheath, the sheath adapted to receive the blade with the blade oriented in a blade plane, a latch element connected to the body, the latch element being movable between a first retention position and a second release position, an engagement element adapted to engage the retention facility when the latch element is in the retention position to prevent extraction of the knife from the holster, and the engagement element being adapted to disengage the retention facility when the latch element is in the release position to enable extraction of the knife from the holster. The retention facility may be a recess and the engagement element may be a protrusion. The retention facility may define a ledge surface facing away from the blade.

### CROSS-REFERENCE TO RELATED APPLICATION

This application claims the benefit of U.S. Provisional Patent Application No. 62/341,186 filed on May 25, 2016, entitled “AUTOMATIC LATCHING TOOL SHEATH,” which is hereby incorporated by reference in its entirety for all that is taught and disclosed therein.

### FIELD OF THE INVENTION

The present invention relates to sheaths, and more particularly to a tool sheath that automatically latches to securely hold the handle of a tool.

### BACKGROUND OF THE INVENTION

Sheaths are close-fitting covers for tools that are elongated in shape, such as the blade portion of a fixed blade knife. Sheaths enable a tool to be attached to an article of clothing. However, the tool is vulnerable to falling out of the sheath if the sheath is not equipped with some method for retaining the tool within the sheath.

A variety of retention methods have been developed to hold a tool, such as the blade portion of a fixed blade knife, within a sheath. These include a strap, a single locking projection together with a matching recess, and double lock mechanisms. These have various disadvantages in that they may not adequately protect a tool from accidental removal from a sheath, may prevent quick removal of a tool from a sheath, and/or may be difficult to latch and/or unlatch.

Therefore, a need exists for a new and improved latching tool sheath that automatically latches to securely hold the handle of a tool. In this regard, the various embodiments of the present invention substantially fulfill at least some of these needs. In this respect, the latching tool sheath according to the present invention substantially departs from the conventional concepts and designs of the prior art, and in doing so provides an apparatus primarily developed for the purpose of providing a latching tool sheath that automatically latches to securely hold the handle of a tool.

### SUMMARY OF THE INVENTION

The present invention provides an improved latching tool sheath, and overcomes the above-mentioned disadvantages and drawbacks of the prior art. As such, the general purpose of the present invention, which will be described subsequently in greater detail, is to provide an improved latching tool sheath that has all the advantages of the prior art mentioned above.

To attain this, the preferred embodiment of the present invention essentially comprises a body defining an elongated sheath, the sheath adapted to receive the blade with the blade oriented in a blade plane, a latch element connected to the body, the latch element being movable between a first retention position and a second release position, an engagement element adapted to engage the retention facility when the latch element is in the retention position to prevent extraction of the knife from the holster, and the engagement element being adapted to disengage the retention facility when the latch element is in the release position to enable extraction of the knife from the holster. The retention facility may be a recess and the engagement element may be a protrusion. The retention facility may define a ledge surface facing away from the blade. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a front view of the current embodiment of a latching tool sheath constructed in accordance with the principles of the present invention.

FIG. 2 is a front exploded isometric view of the current embodiment of the latching tool sheath of FIG. 1.

FIG. 3 is a rear exploded isometric view of the current embodiment of the latching tool sheath of FIG. 1.

FIG. 4 is a side sectional view taken along line 4-4 FIG. 1.

FIG. 5 is a front view of the current embodiment of the latching tool sheath of FIG. 1 with the front cover removed.

FIG. 6 is a left side view of the current embodiment of a tool constructed in accordance with the principles of the present invention for use with the latching tool sheath of FIG. 1.

FIG. 7 is a front view of the current embodiment of the latching tool sheath of FIG. 1 with the tool of FIG. 6 holstered in the latched condition.

FIG. 8 is a rear isometric view of the current embodiment of the latching tool sheath of FIG. 1 with the tool of FIG. 6 holstered in the latched condition.

FIG. 9 is a side sectional view taken along line 9-9 of FIG. 7

FIG. 10 is a front view of the current embodiment of the latching tool sheath of FIG. 1 with the pendulum deflected to the right and with the tool and front cover removed.

FIG. 11 is a front view of the current embodiment of the latching tool sheath of FIG. 1 with the pendulum deflected to the right and with the tool removed.

FIG. 12 is a front view of the current embodiment of the latching tool sheath of FIG. 1 with the tool of FIG. 6 holstered in the unlatched condition with the pendulum deflected to the right.

FIG. 13 is a side sectional view taken along line 13-13 of FIG. 11.

FIG. 14 is a side sectional view taken along line 14-14 of FIG. 12.

FIG. 15 is a front view of the current embodiment of the latching tool sheath of FIG. 1 with the pendulum deflected to the left and with the tool and front cover removed.

The same reference numerals refer to the same parts throughout the various figures.

### DESCRIPTION OF THE CURRENT EMBODIMENT

An embodiment of the latching tool sheath of the present invention is shown and generally designated by the reference numeral 10.

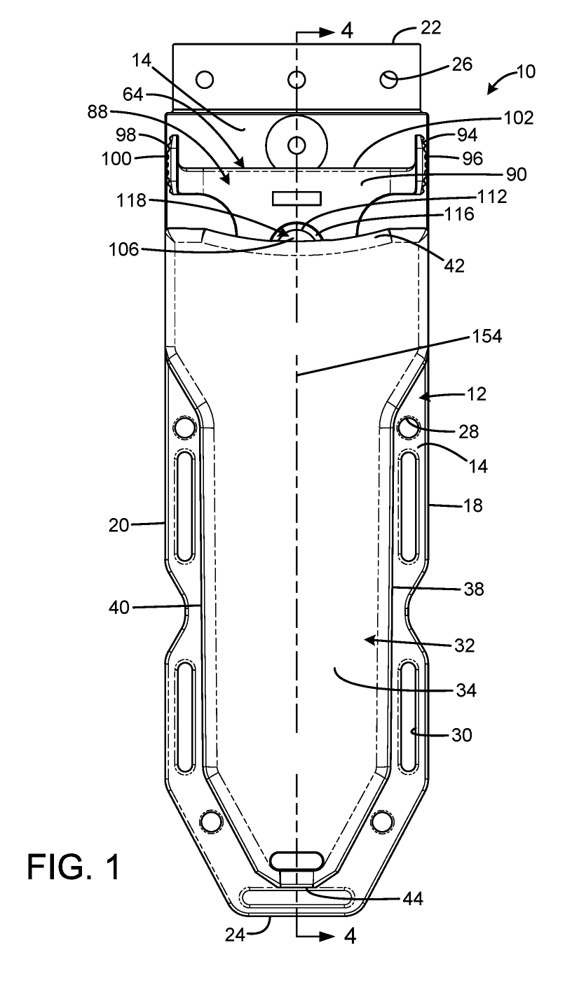

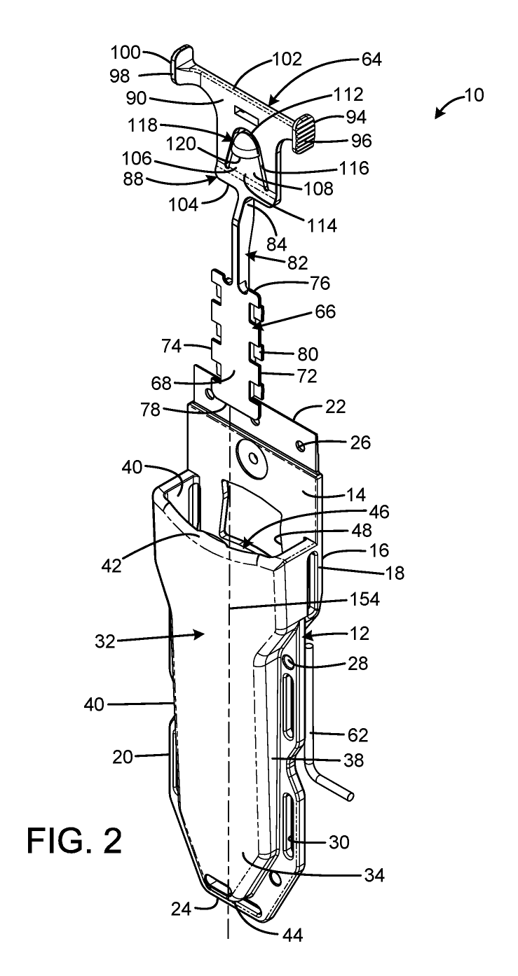

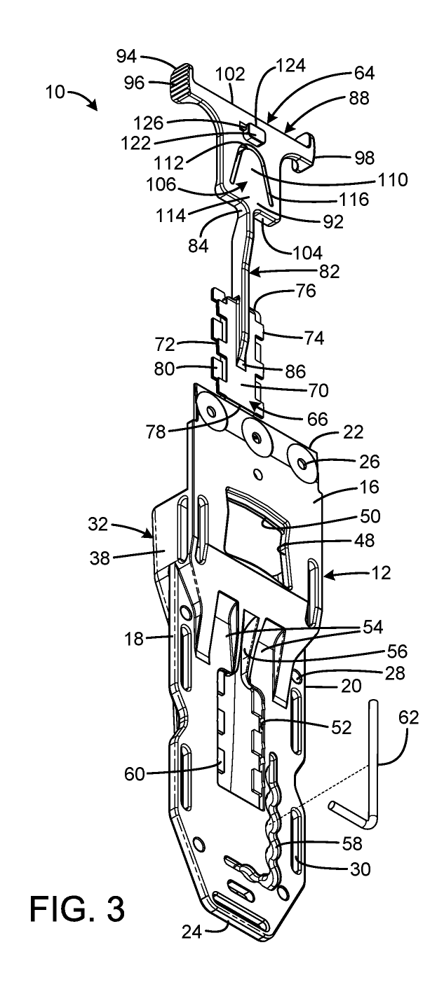

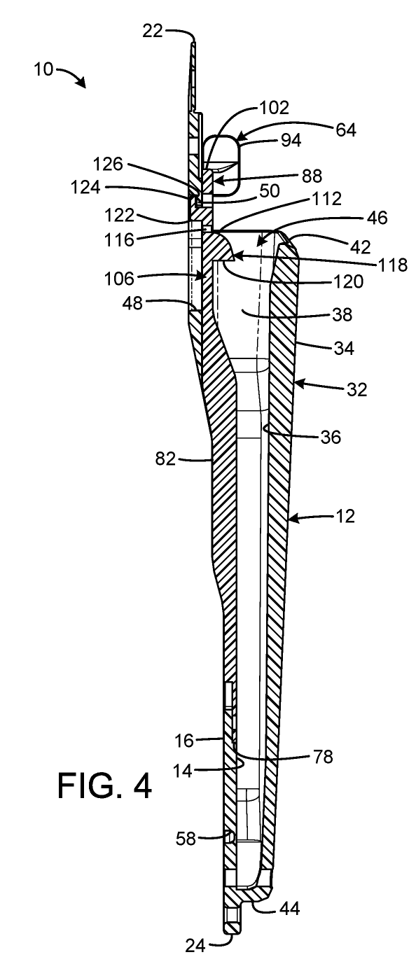

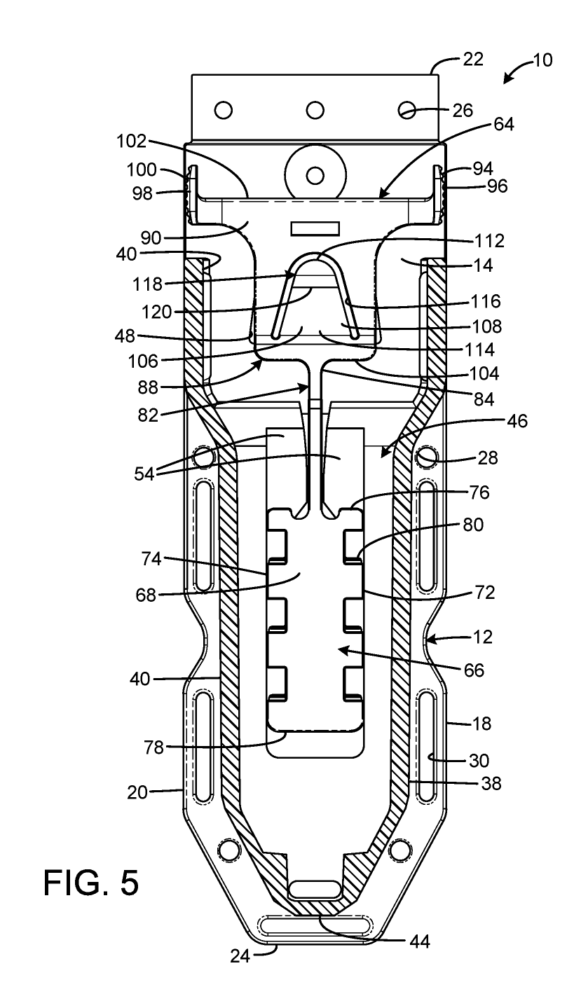

FIGS. 1-5 illustrate the improved latching tool sheath 10 of the present invention. More particularly, the latching tool sheath is a knife holster that includes a body 12, a front cover 32, and a latch mechanism 64. FIG. 5 illustrates the body of the latching tool sheath with the front cover removed. The body has a front 14, rear 16, right side 18, left side 20, top 22, and bottom 24. The body defines a plurality of apertures 26 near the top and a plurality of apertures 28 and slots 30 along both sides and the bottom. The body also defines an aperture 48 with a guide rail 50 extending downwards from the top of the aperture. The body further includes a pair of support ridges 54 that define a flexible shaft slot 56 between them. The body defines a paddle slot 52 immediately below the flexible shaft slot. The paddle slot has a plurality of crenellations 60 on the right and left sides. The body also defines an Allen wrench slot 58 that extends below the paddle slot and releasably receives an Allen wrench 62. The body further defines a sheath axis 154.

A front cover 32 is affixed to the front 14 of the body 12. The front cover has a front 34, rear 36, right side 38, left side 40, top 42, and bottom 44. The left and right sides position the front of the front cover above the front of the body to define an elongate pocket 46 between the rear of the front cover and the front of the body.

A latch mechanism/latch element 64 is attached to the body 12 by a paddle 66 that is received within the paddle slot 52. The paddle has a front 68, rear 70, right side 72, left side 74, and top 76. The right and left sides of the paddle define a plurality of crenellations 80. When the paddle is received within the paddle slot, the crenellations 80 on the paddle mate with the crenellations 60 on the right and left sides of the paddle slot to secure the paddle within the paddle slot.

The latch mechanism 64 further includes a flexible shaft 82 having a top 84 and a bottom 86.

The bottom of the flexible shaft is attached to the rear 70 of the paddle 66. When the latch mechanism is attached to the body 12, a middle portion of the flexible shaft is received between the support ridges 54 within the flexible shaft slot 56.

The bottom 104 of a pendulum 88 is attached to the top 84 of the flexible shaft 82. The pendulum also has a front 90, rear 92, right button 94 with serrations 96, left button 98 with serrations 100, and top 102. The serrations on the buttons facilitate engagement of a fingertip with the buttons without slipping. The pendulum defines a gap 116 that enables a central portion of the pendulum to become a flexible element/engagement element 106. The flexible element has a front 108, rear 110, top 112, and bottom 114. The bottom of the flexible element is secured to the pendulum. The top front of the flexible element includes a forwardly protruding tooth 118 having a bottom flat shelf/hook surface 120. The bottom flat shelf faces toward a free end of the sheath 10 (bottom 24). The remainder of the tooth above the bottom flat shelf has sloped lateral cam surfaces. A guide block 122 is centrally located on the rear of the pendulum immediately above the top of the flexible element. The guide block has a top 124 that defines a slot 126. When the latch mechanism 64 is attached to the body, the slot 126 slidably receives the guide rail 50 that extends downwards from the top of the aperture 48. The guide block and pendulum are free to slide from side to side along an arc defined by the guide rail, but the guide rail prohibits forward and rearward movement of the guide block and pendulum. Thus, the latch mechanism is movable between a first retention position and a second release position. The flexible element is aligned with the aperture 48, so the top of the flexible element is movable with respect to the latch mechanism and is free to deflect rearward through the aperture. The latch mechanism moves in a path perpendicular to the motion of the flexible element. The flexible element is movable with respect to the latch mechanism between an engagement position when the latch element is in the retention position, and a disengagement position when the latch element is in the release position.

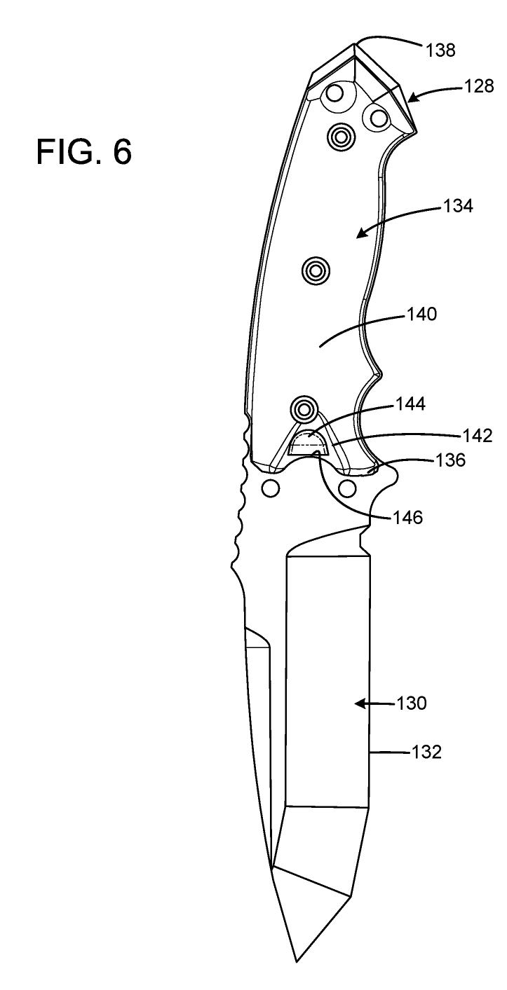

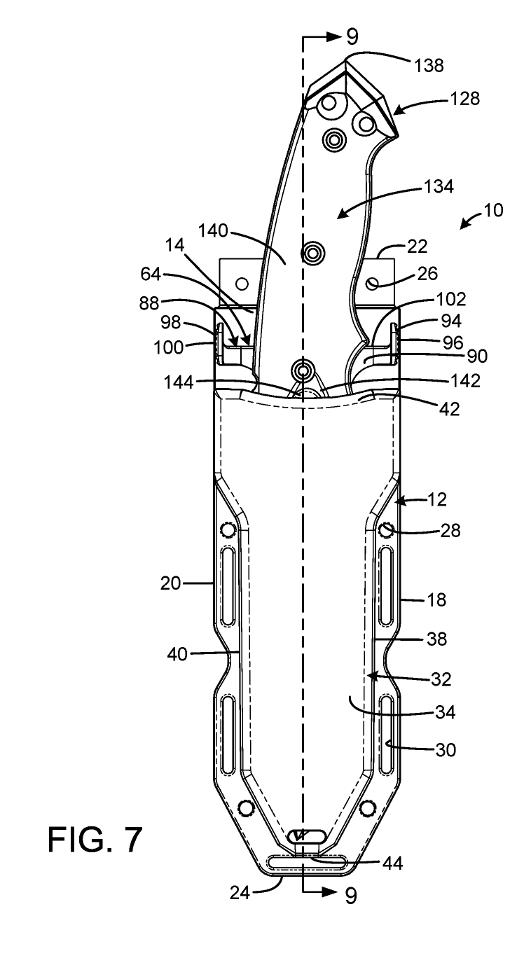

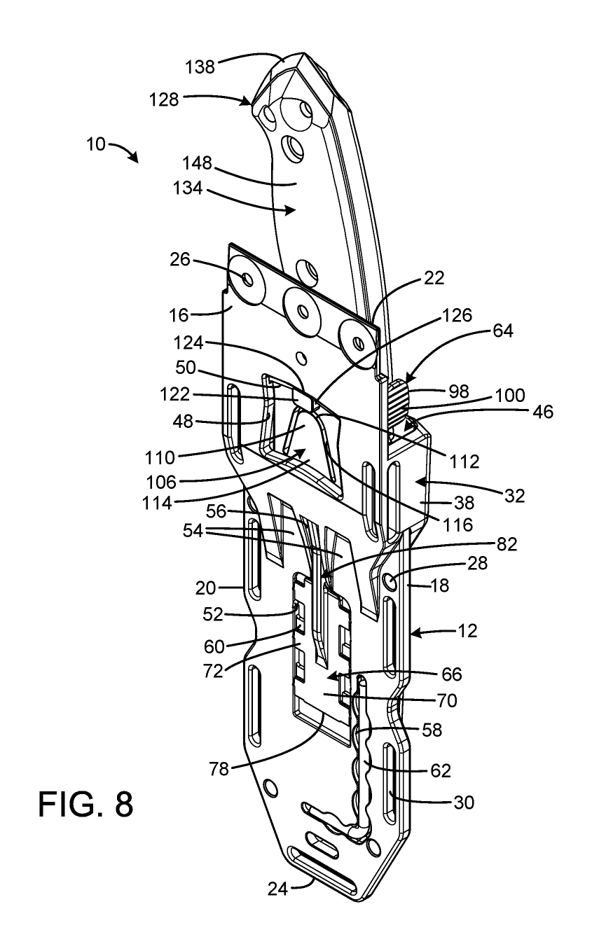

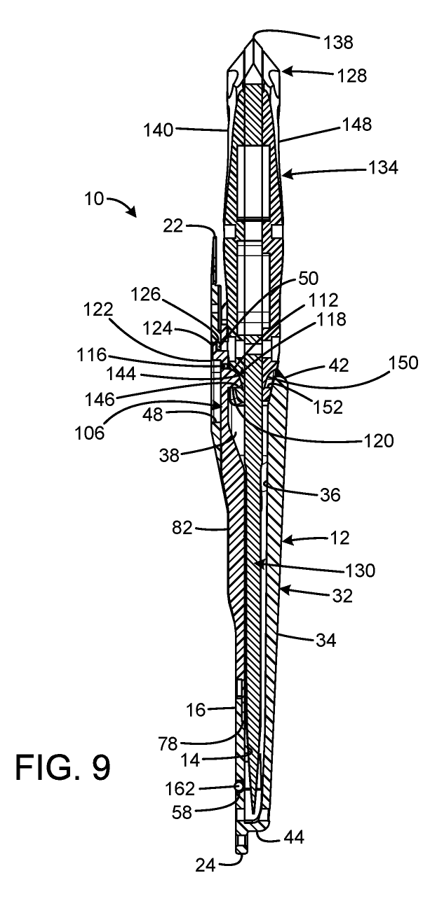

FIGS. 6-9 illustrate the improved tool 128 and latching tool sheath 10 of the present invention. More particularly, the tool is a fixed blade knife having a blade 130 with a cutting edge 132 and a handle 134. FIG. 6 shows the knife removed from the latching tool sheath, and FIGS. 7-9 show the knife holstered in the latching tool sheath with the latching tool sheath in the latched condition and with the blade oriented in a blade plane. The handle has a front 136, rear 138, left side 140, and right side 148. The front left side of the handle defines a generally triangular-shaped ramp 142, which includes sloped cam surfaces facing laterally to the length of the knife, and further defines a central pocket/recess 144 having a flat bottom shelf/ledge surface 146, which acts as a retention facility. The bottom shelf/step surface faces away from the blade in the current embodiment. The central pocket is sized to closely receive the tooth 118 on the flexible element 106 when the blade of the knife is fully inserted into the pocket 46 of the latching tool sheath. The sloped lateral cam surfaces on the tooth motivate the flexible element out of the central pocket as the latch mechanism 64 is moved to the release position. The front right side/opposite side of the handle also defines an identical ramp with an opposed central pocket 150 having a flat bottom shelf/ledge surface 152, which is also part of the retention facility and enables the knife to be holstered in the latching tool sheath with the cutting edge either forward or backward while still enabling the tooth on the flexible element to be closely received within one of the central pockets. When inserting the knife into the sheath, the flexible element deflects rearward through the aperture 48. The ramp facing the tooth guides the tooth towards the central pocket facing the tooth as spring tension provided by the flexible shaft causes the pendulum to self-center, thereby aligning the tooth with the central pocket. Once the knife handle is fully inserted, the tooth snaps into the central pocket. Once the tooth is received within the central pocket, the knife cannot be lifted out of the sheath because of the engagement between the bottom flat shelf/hook surface 120 of the tooth and the bottom flat shelf/ledge surface 146 of the central pocket 144 when the latch mechanism/latch element is in the retention position. Thus, the flexible element/engagement element is adapted to engage the retention facility when the latch mechanism/latch element is in the retention position to prevent extraction of the knife from the holster. Furthermore, the latch mechanism is operable to move in a latch plane parallel to the plane of the blade and displaces from the sheath axis 154 in one lateral direction. The flexible element moves in a plane perpendicular to the latch plane and the blade plane and displaces from the sheath axis in a perpendicular lateral direction.

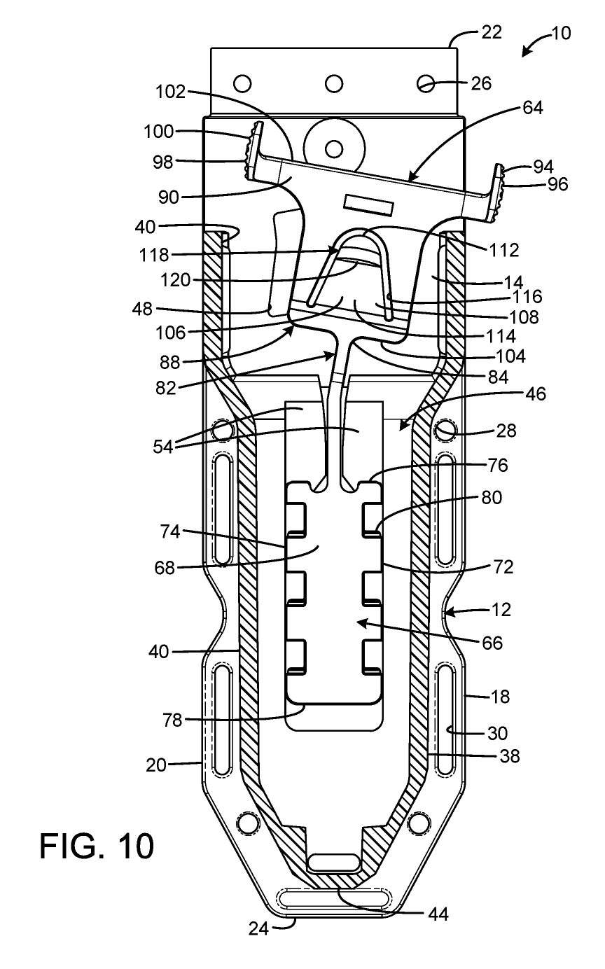

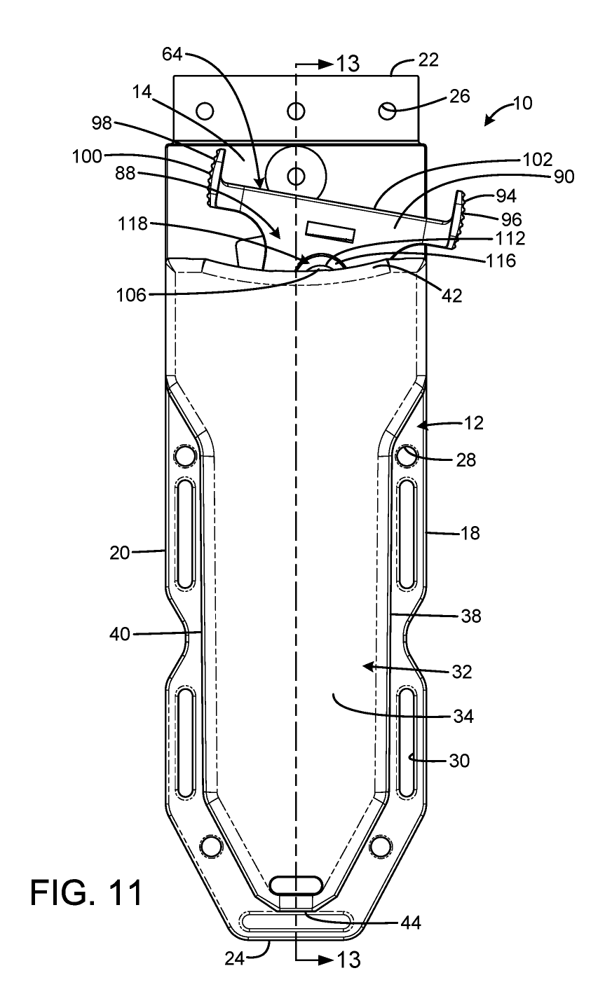

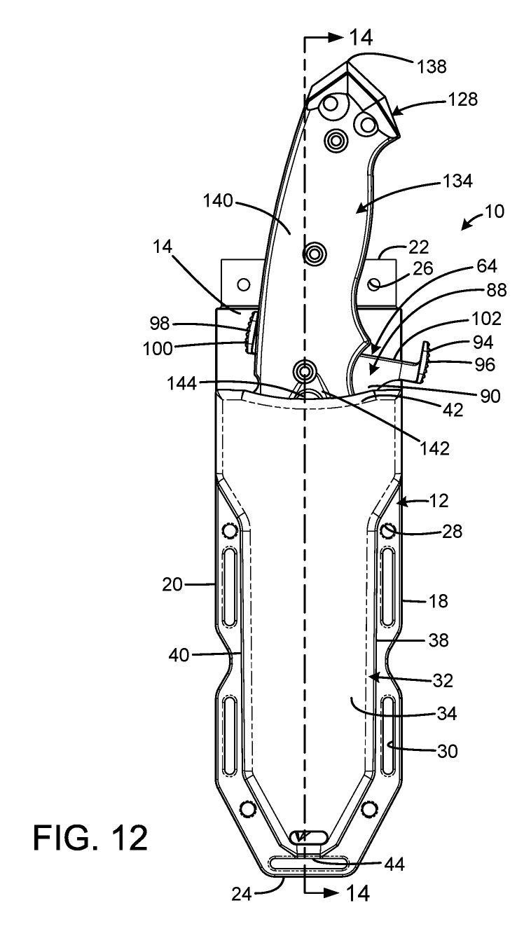

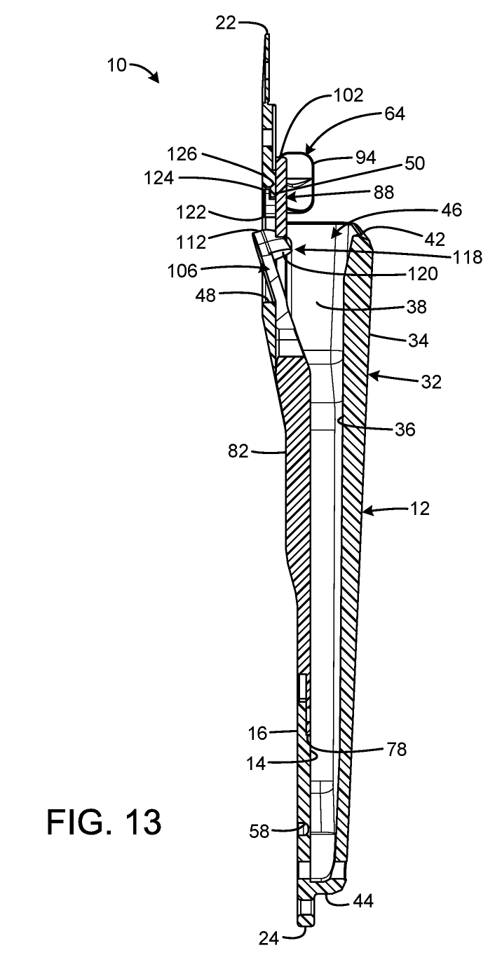

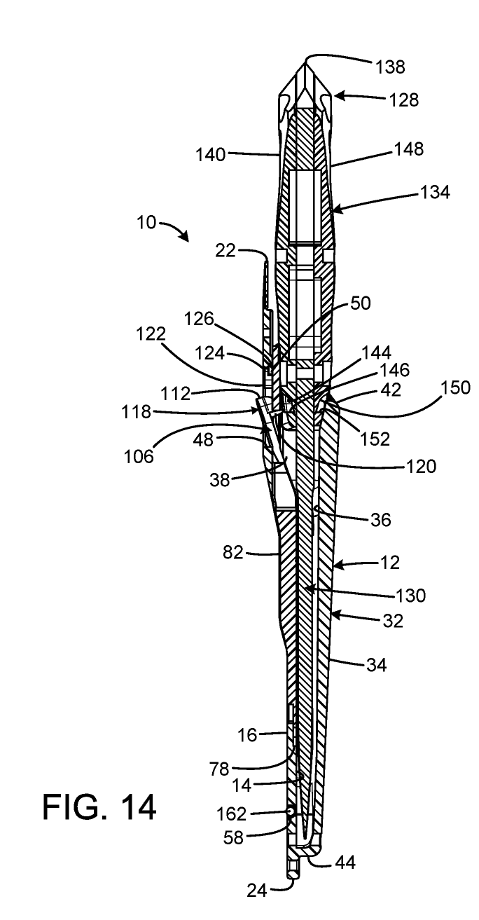

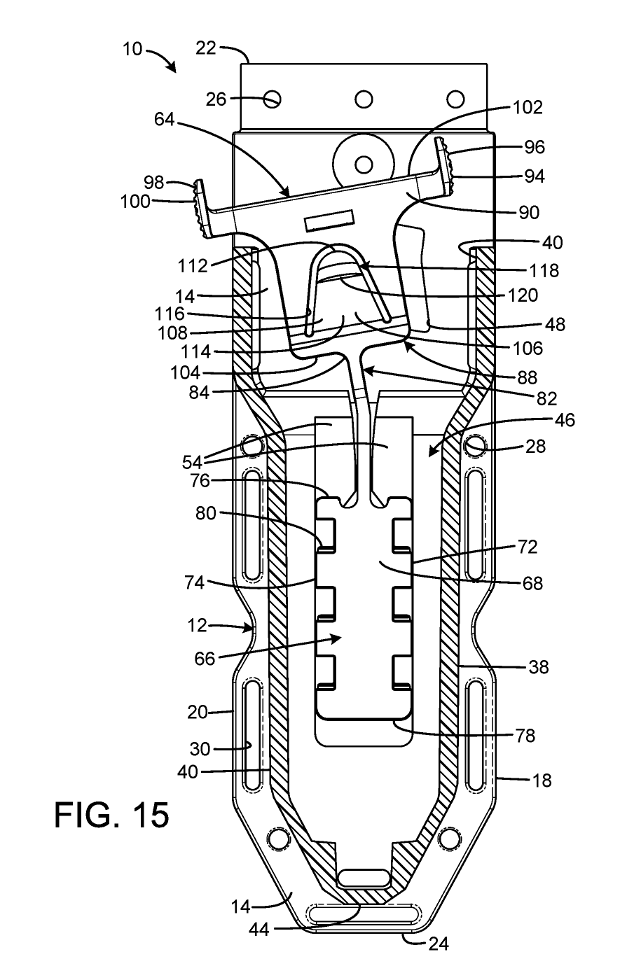

FIGS. 10-15 illustrate the improved tool 128 and latching tool sheath 10 of the present invention. More particularly, the latching tool sheath is shown in the unlatched condition. In FIGS. 10-14, the left button 98 has been pushed laterally to place the latching tool sheath in the unlatched condition. In FIG. 15, the right button 94 has been pushed laterally to place the latching tool sheath in the unlatched condition. FIGS. 10 and 15 show the body 12 of the latching tool sheath with the front cover 32 removed. The engagement of the slot 126 of the guide block 122 with the guide rail 50 permits only lateral movement of the pendulum 88 along the arc defined by the guide rail when the right or left button is pushed. As one of the buttons is pushed with a fingertip, the flexible shaft 82 flexes, and the flexible element 106 is deflected rearward through the aperture 48 as the tooth 118 is forced out of the central pocket 144 and onto the ramp 142. Once the tooth is forced out of the central pocket, the knife 128 can be easily removed from the latching tool sheath. Thus, the flexible element/engagement element is adapted to disengage the retention facility when the latch mechanism/latch element is in the release position to enable extraction of the knife from the holster. Once the knife handle no longer contacts the tooth, the flexible element springs back to a neutral position without deflection into the aperture. Once the button is released, spring tension in the flexible shaft returns the pendulum to a neutral, centered position where the flexible shaft is not flexed. The latching tool sheath is then ready for the knife to be inserted back into the pocket 46 and to automatically return to the latched condition with the tooth received in one of the central pockets 144, 150 on the knife handle 134. Thus, the latch element is biased towards the retention position, and the engagement element is biased towards the engagement position.

While a current embodiment of a latching tool sheath has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, although the front cover and body are described as separate parts for clarity, the front cover and body can be a unitary element. Furthermore, although the latch mechanism is described as having a pendulum, a flexible shaft, and a paddle as separate parts for clarity, the latch mechanism can be a unitary element. In addition, the latch mechanism can be made of a thermoplastic to provide a natural spring tension when the flexible element and flexible shaft are deflected from a neutral position. In alternative embodiments of the present invention, the tooth and pocket can be gender reversed; there can be more than one tooth and pocket; there could be multiple teeth in a repeat or progressive pattern to provide a ratcheting surface; the central pocket can be located on the blade of the knife; the strength of the tooth and central pocket could be enhanced with inserts of a stronger material, such as a metal; the movements of the locking mechanism can be accomplished by articulate rigid elements position by springs; the central pocket can be a slot where the tooth slides out with lateral movement without requiring deflection; and the tooth and central pocket can be duplicated on both sides of the latching tool sheath and knife to simultaneously latch to both sides of the knife.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A knife holster for retaining a knife having a blade and a retention facility, the holster comprising:
a body defining an elongated sheath;
the sheath adapted to receive the blade with the blade oriented in a blade plane;
a latch element connected to the body;
the latch element being movable between a first retention position and a second release position;
an engagement element adapted to engage the retention facility when the latch element is in the retention position to prevent extraction of the knife from the holster; and
the engagement element being adapted to disengage the retention facility when the latch element is in the release position to enable extraction of the knife from the holster.

2. The knife holster of claim 1 wherein the retention facility is a recess and the engagement element is a protrusion.

3. The knife holster of claim 1 wherein the retention facility defines a ledge surface facing away from the blade and the engagement element has a hook surface adapted to engage the ledge surface when the latch element is in the retention position.

4. The knife holster of claim 1 wherein the engagement element is movable with respect to the latch element.

5. The knife holster of claim 4 wherein the latch element moves in a path perpendicular to the motion of the engagement element.

6. The knife holster of claim 1 wherein the engagement element is movable with respect to the latch element between an engagement position when the latch element is in the retention position, and a disengagement position when the latch element is in the release position.

7. The knife holster of claim 1 wherein the latch element is operable to move in a latch plane parallel to the blade plane.

8. The knife holster of claim 7 wherein the engagement element moves in a plane perpendicular to the latch plane.

9. The knife holster of claim 1 wherein the engagement element moves in a plane perpendicular to the blade plane.

10. The knife holster of claim 1 where the engagement element has a hook surface facing toward a free end of the sheath, and the engagement element has sloped lateral cam surfaces such that the cam surfaces motivate the engagement element out of the blade's retention facility as the latch element is moved to the release position.

11. A knife and holster system comprising:
a knife having a blade and defining a retention facility;
a holster comprising a body defining an elongated sheath;
the sheath adapted to receive the blade with the blade oriented in a blade plane;
a latch element connected to the body;
the latch element being movable between a first retention position and a second release position;
an engagement element adapted to engage the retention facility when the latch element is in the retention position to prevent extraction of the knife from the holster; and
the engagement element being adapted to disengage the retention facility when the latch element is in the release position to enable extraction of the knife from the holster.

12. The system of claim 11 wherein the knife includes a handle and the retention facility is a recess in the handle.

13. The system of claim 11 wherein the retention facility comprises a pair of opposed recesses on opposite sides of the knife.

14. The system of claim 11 wherein the retention facility includes a step surface facing away from the blade.

15. The system of claim 11 wherein the retention facility includes sloped cam surfaces facing laterally to the length of the knife.

16. The system of claim 11 wherein the retention facility defines a ledge surface facing away from the blade and the engagement element has a hook surface adapted to engage the ledge surface when the latch element is in the retention position.

17. The system of claim 11 wherein the engagement element is movable with respect to the latch element.

18. The system of claim 17 wherein the latch element moves in a path perpendicular to the motion of the engagement element.

19. The system of claim 11 wherein the engagement element is movable with respect to the latch element between an engagement position when the latch element is in the retention position, and a disengagement position when the latch element is in the release position.

20. The system of claim 11 wherein the latch element is operable to move in a latch plane parallel to the plane of the blade.

21. The system of claim 20 wherein the engagement element moves in a plane perpendicular to the latch plane.

22. The system of claim 11 wherein the engagement element moves in a plane perpendicular to the plane of the blade.

23. The system of claim 11 where the engagement element has a ledge surface facing toward a free end of the sheath, and the engagement element has sloped lateral cam surfaces such that the cam surfaces motivate the engagement element out of the blade's retention facility as the latch element is moved to the release position.

24. The system of claim 11 wherein the latch element is biased towards the retention position.

25. The system of claim 11 wherein the engagement element is biased towards the engagement position.

26. The system of claim 11 wherein the latch element is biased towards the retention position and the engagement element is biased towards the engagement position.
